(19) United States
(12) Patent Application Publication
(10) Pub. No.: US 2007/0038636 A1
(43) Pub. Date: Feb. 15, 2007

(54) Video resume internet system

(76) Inventors: Benjamin L. Zanghi JR., Blackwood, NJ (US); Domenic J. Zanghi, Sewell, NJ (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 11/202,772

(22) Filed: Aug. 12, 2005

(51) Int. Cl. G06F 17/30

(52) U.S. Cl. 707/10

(57) ABSTRACT

A video resume employment system for determining the employability of a job seeker by an employer in a video resume employment system includes providing a video employment resume of the job seeker, the video employment resume including employment information with respect to the job seeker for making an employment related determination by the employer. The video employment resume is transmitted to the video employment resume system and stored in a video resume database. The video employment resume is accessed from the video resume database by the employer from a location remote from the video employment resume system to provide an accessed video resume.

### BACKGROUND OF THE INVENTION

1. Fleld of Invention

This invention relates to the field of employment services and, in particular, to the field of providing employment services to users disposed at locations remote from each other.

2. Description of Related Art

Systems providing employment services disposed at remote locations are known in the prior art. For example, U.S. Pat. No. 5,745,882, entitled “Electronic Classified Advertising Interface Method and Instructions with Continuous Search Notification”, issued Apr. 28, 1998 to Matthew J. Bixler, et al., discloses a telephone keypad interface for an electronic classified advertising system. However, the Bixler system requires a telephone network and the inherent limitations of a telephone keypad in order to operate.

U.S. Pat. No. 5,592,375, entitled “Computer-assisted System for Interactively Brokering Goods or Services between Buyers and Sellers issued Jan. 7, 1997 to Bardwell C. Salnon, et al., teaches an electronic employee bargaining marketplace, with the employer able to review in detail the qualifications of a pool of candidates. Match selection criteria are entered by the buyer. Additionally, U.S. Pat. No. 5,996,006, entitled “Internet-audiotext Electronic Advertising System with Enhanced Matching and Notification”, issued Nov. 30, 1999 to Gregory J. Speicher, discloses a computer based matching system including automatic advertiser notification when a suitable match is found.

It is known to provide text only employment services. For example, U.S. Pat. No. 6,370,510 teaches a method and apparatus for providing an interactive computer-driven employment recruiting service. The method and apparatus enables an employer to advertise available positions on the Internet, directly receive text only resumes from prospective candidates, and organize and screen the received resumes. The method and apparatus further is capable of monitoring employment advertisements for a job seeker and automatically notifying the job seeker when a position for which the job seeker is suitable becomes available. The method and apparatus further enables a plurality of companies to advertise job positions at a single location accessible via the Internet by a job seeker, and enables the job seeker to communicate a text only resume directly with a company via the Internet if the job seeker is interested in exploring further information pertaining to an available position at that company.

Another reference teaching a text only employment service is U.S. Pat. No. 5,978,768 which teaches a method and apparatus for providing an interactive computer-driven employment recruiting service. The method and apparatus enables an employer to advertise available positions on the Internet, directly receive text only resumes from prospective candidates, and organize and screen the received resumes. The method and apparatus further is capable of monitoring employment advertisements for a job seeker and automatically notifying the job seeker when a position for which the job seeker is suitable becomes available. The method and apparatus further enables a plurality of companies to advertise job positions at a single location accessible via the Internet by a job seeker, and enables the job seeker to communicate text only messages directly with a company via the Internet if the job seeker is interested in exploring further information pertaining to an available position at that company.

All references cited herein are incorporated herein by reference in their entireties.

### BRIEF SUMMARY OF THE INVENTION

### SUMMARY OF THE INVENTION

A video resume employment method for determining the employability of a job seeker by an employer in a video resume employment system includes providing a video employment resume of the job seeker, the video employment resume including employment information with respect to the job seeker for making an employment related determination by the employer. The video employment resume is transmitted to the video employment resume system and stored in a video resume database. The video employment resume is accessed from the video resume database by the employer from a location remote from the video employment resume system to provide an accessed video resume. The employer views the accessed video resume and determines the employability of the job seeker in accordance with the viewing of the accessed video resume. An employment interview is provided in accordance with the employability determination.

Further in accordance with the invention, the video employment resume is transmitted by the job seeker. A video recording device can be transmitted to the job seeker by the video resume employment system for the providing of the video employment resume by the job seeker. The employment information is verbally described by the job seeker. The video employment resume is transmitted by way of the Internet. The storing of the video employment resume includes the further steps of receiving a plurality of video employment resumes and storing the video employment resumes of the plurality of video employment resumes in the video resume database and sorting the plurality of video employment resumes in accordance with a selected job related parameter. The job related parameter can be occupation, education, work experience or geographic location or any other related criteria.

The accessing of the video employment resume by the employer includes accessing by way of the Internet. The accessed resume can be forwarded to a further location, the further location being remote from the video employment resume system and from the accessing employer. The resume is forwarded to the further location by way of the Internet.

The method of the invention also includes the steps of listing an employer help wanted advertisement on the video employment resume system to provide a listed help wanted advertisement and viewing the listed help wanted advertisement by a viewing job seeker. The viewing job seeker responds to the listed help wanted advertisement in accordance with the viewing of the listed help wanted advertisement. A responding resume is transmitted to the listing employer by the viewing job seeker by way of the video employment resume system.

In a system including a plurality of video employment resume systems having corresponding employers, the responding resume stored on a first video employment resume system is transmitted to an employer on a second video employment resume system. In a system having a plurality of job seekers each having a corresponding video employment resume, the method of the invention includes the steps of providing the employer with a list of job seekers of the plurality of job seekers and selecting a job seeker of the list of job seekers by the employer in accordance with an employability determination. An identification of the selected job seeker is transmitted by the employer to the video employment resume system and a corresponding a video employment resume is transmitted from the video employment resume database to the employer in accordance with the identification.

In the video employment resume system of the present invention, a user signs up for an account at the website of the system. If the job seeker owns a PC and a web camera, the job seeker downloads software from the video employment resume system which includes instructions. When technology exists for computers to have built-in web cameras, that new technology can be utilized for transmitting job seekers video resumes via the Internet to the video resume data base.

The job seeker records according to the instructions and creates his/her own video resume and posts the video resume to be reviewed by potential employers. If the job seekers do not own a personal computer and a web camera, they can purchase a web camera from the video employment resume system. The camera is then shipped to them. If the job seekers do not wish to purchase a camera in this manner, they can schedule an appointment to meet with representatives of the video employment resume system to professionally create their video resume for them. The video resume created in this manner is then posted on the website of the video employment resume system.

Job seekers can search a job bank and apply for positions by sending a message that links the employer to the job seekers video resume. The employer receives an email alerting it that there is a video resume to review. In order for employers to use the video employment resume system, they must sign up for access to browse the video resume bank. They will be provided with a password which will enable them to access the resume bank. Employers can also post jobs for job seekers to review and apply for. When job seekers see jobs posted in this manner, they can request that their video resumes be sent to the corresponding employer. Employers can also post jobs using video job postings to describe the position and qualifications that they desire. Additionally, they can post a company profile.

### BRIEF DESCRIPTION OF SEVERAL VIEWS OF THE DRAWINGS

The invention will be described in conjunction with the following drawings in which like reference numerals designate like elements and wherein:

FIG. 1 is a high level schematic representation of the system of the present invention.

FIGS. 2A-K are a more detailed representation of the system of the present invention.

### DETAILED DESCRIPTION OF THE INVENTION

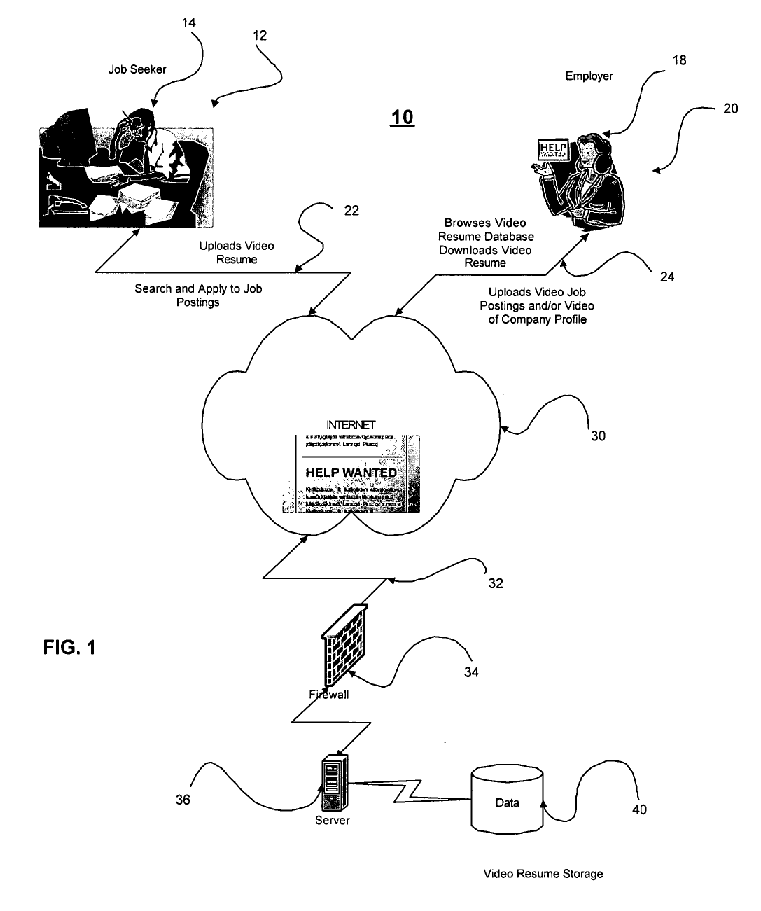

Referring now to FIG. 1, there is shown the video employment resume system 10 of present invention. Within the video employment resume system 10, a job seeker 14 having a personal computer and a web camera (web cam) at a job seeker location 12 can create a personal video resume using the web cam or any other web device capable of creating a video while located at the location 12. In an alternate embodiment of the invention, the job seeker 14 can request that such a web cam be provided to the job seeker location 12 by the vendor or entity operating the video employment resume system 10. In the latter case, the video cam can be purchased from the vendor or entity operating the system 10 or rented from that entity free or for a predetermined rental charge.

When the video resume is created by the job seeker 14, it is transmitted from the job seeker location 12 by way of an Internet connection 22 to the Internet system 30. The video resume from the job seeker 14 is received from the Internet system 30 by way of the Internet connection 32 and applied to a video employment resume system server 36 by way of a firewall 34. The video employment resume system 10 can provide editing services for editing a video resume received in this manner. The server 36 stores the video resume in a video resume database 40.

An employer 18 located at an employer location 20, having an Internet connection 24 to the Internet system 30, can access video resumes from the video resume database 40 of the video employment resume system 10. The employer location 20 is remote from the job seeker location 12. The employer 18 can thus browse the video resumes stored in the video resume database 40 and select video resumes for downloading according to predetermined employment criteria.

Additionally, the employer 18 can upload video job postings representative of jobs to be filled and company videos, such as company profiles, for storage in the video resume database 40 by way of Internet connection 24 and the Internet system 30. The job seeker 14 can browse uploaded postings from the employer 18 while located at the job seeker location 12 by accessing the video resume database 40 by way of the Internet system 30.

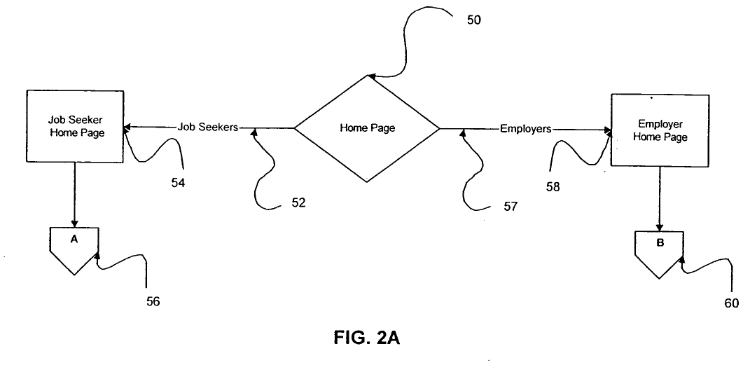

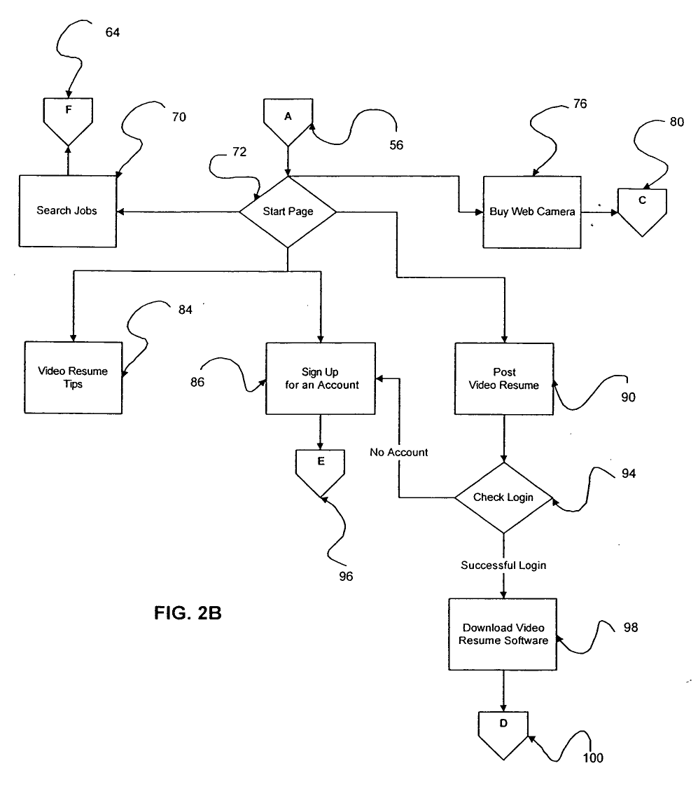

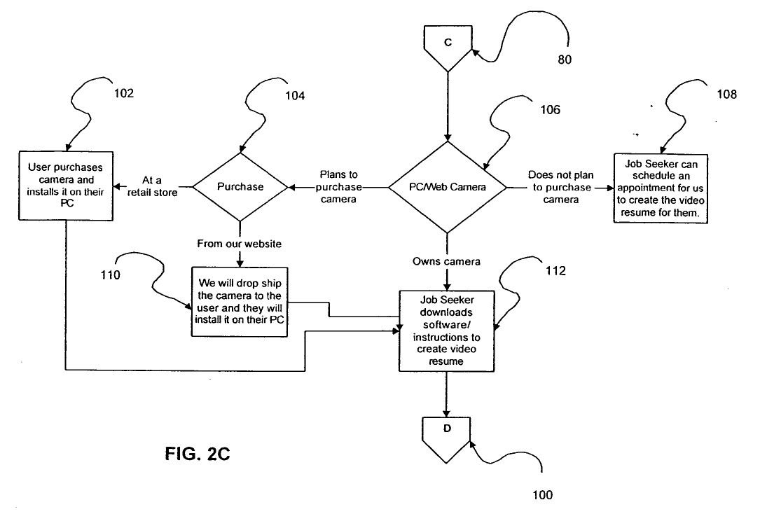

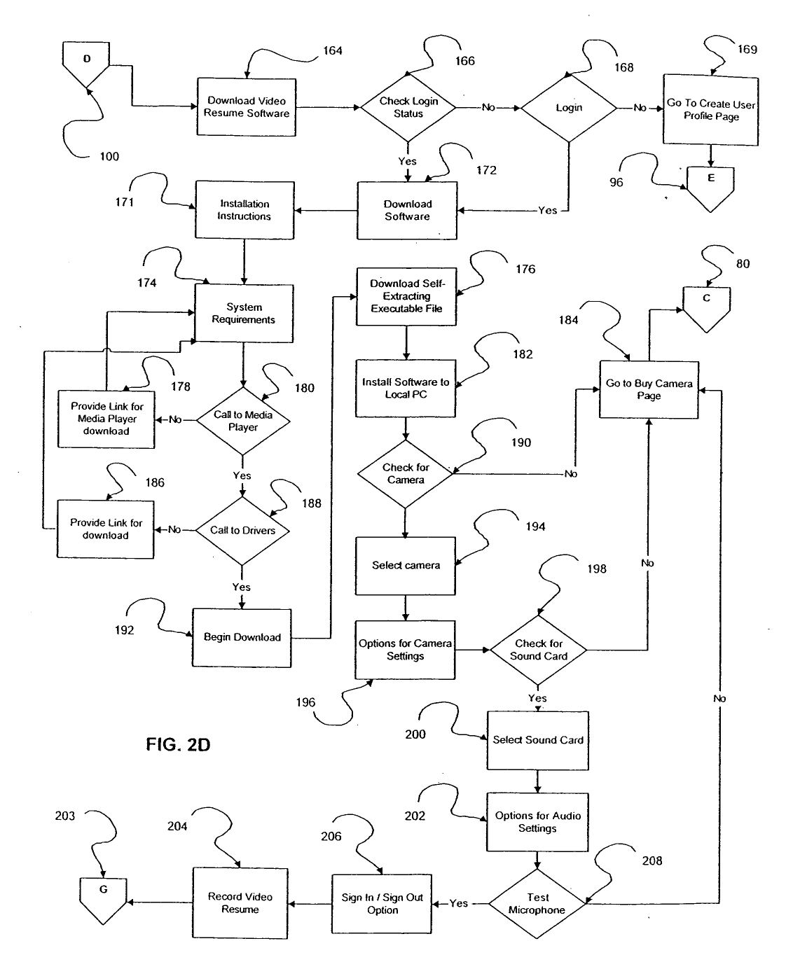

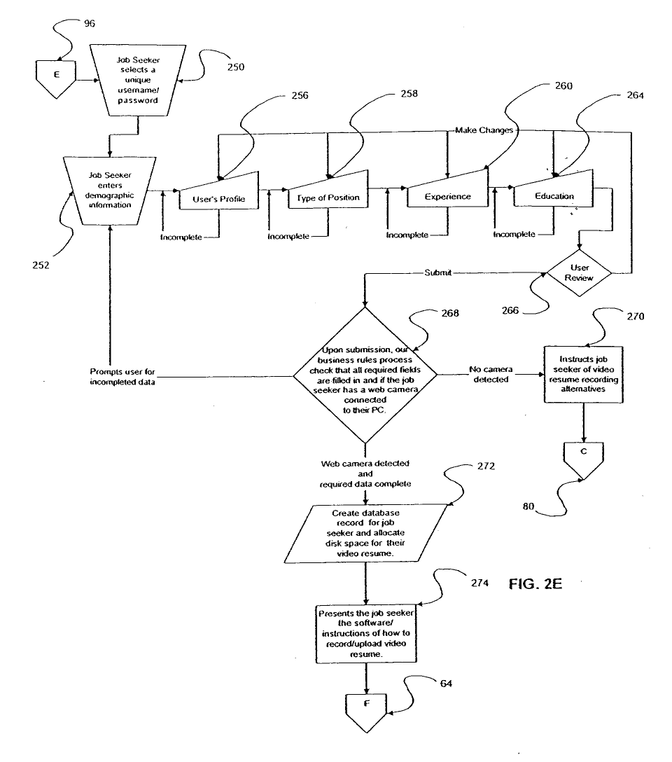

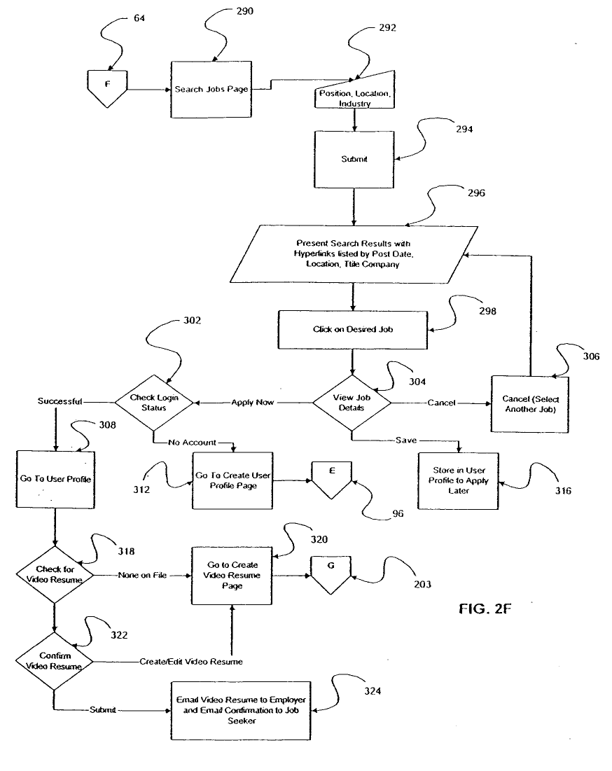

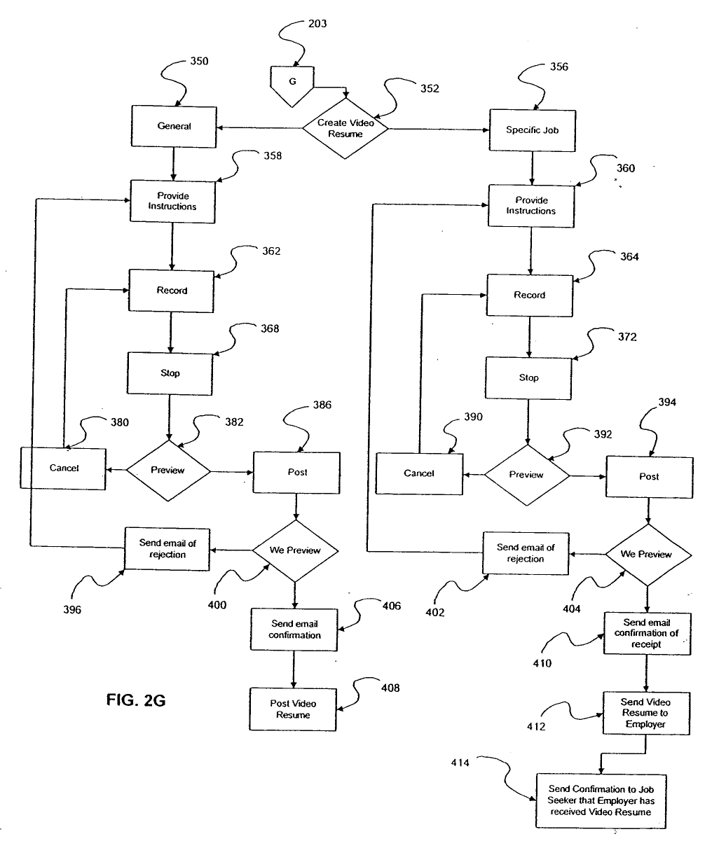

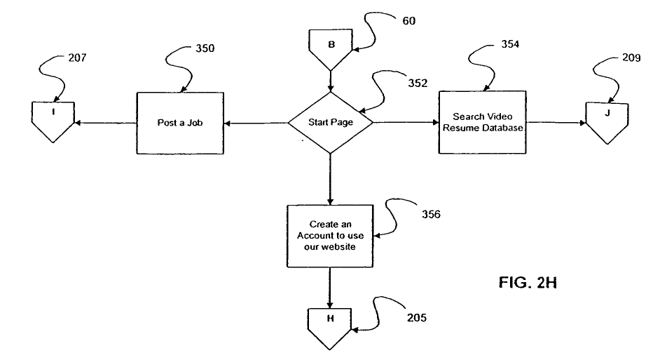

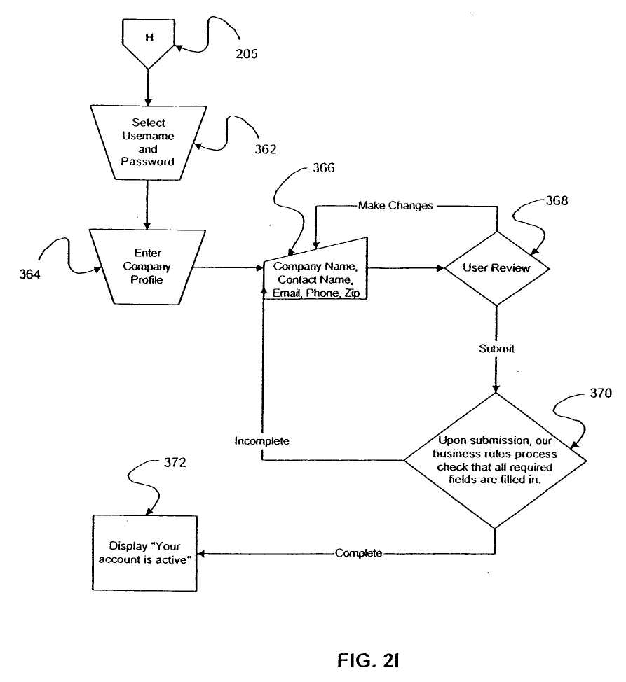

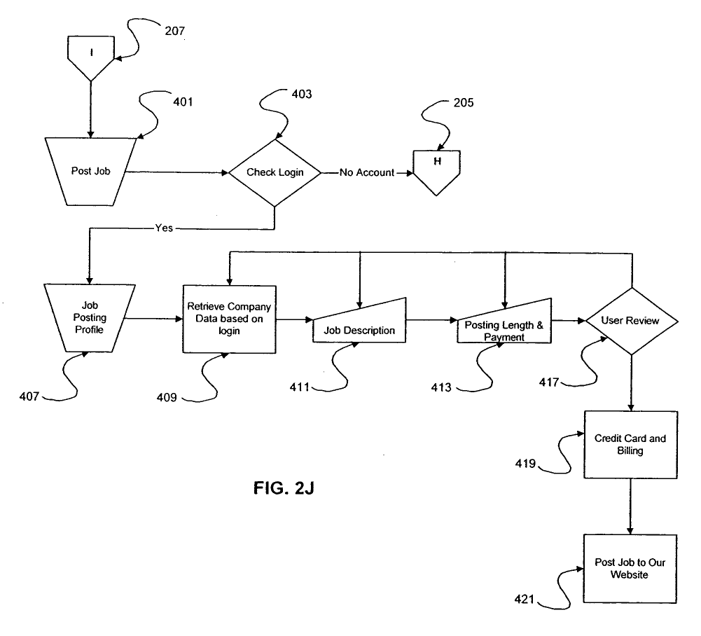

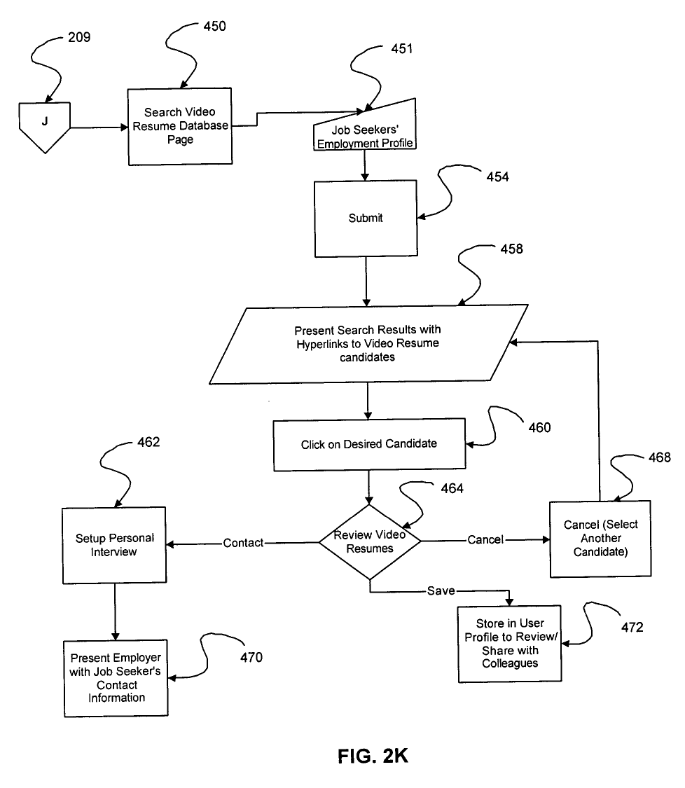

Referring now to FIGS. 2A-K, there is shown an overview of the video employment resume system 10. A video resume system home page 50 of the video employment resume system 10 having a job seeker home page 54 at the job seeker location 12 communicates with the job seeker 14 by way of a communication link 52. Additionally, the home page 50 communicates with an employer 18 having an employer home page 58 at an employer location 20 by way of a communication link 57. The preferred embodiment of the communication links 52, 57 is the Internet.

However, It will be understood by those skilled in the art that any type of communication link can be used. For example, any type of analog, digital, optical or other electromagnetic (such as microwave) communication channel suitable for transmitting video images can be used.

When the video employment resume system 10 communicates with the job seeker home page 54, execution proceeds in a path A to FIG. 2B where a start page 72 is encountered with the linkage between these figures being shown by a item 56 in FIG. 1. If the job seeker 14 does not have a web camera for creating a video resume and must buy one, as shown in block 76, execution proceeds by way of connectors 80 to FIG. 2C. In the operations represented in FIG. 2C a video cam can be obtained or arrangements can be made for the vendor or operator of the video resume system 10 to create the video resume. The operations represented in FIG. 2C are described in detail below.

If the job seeker 14 does have a web camera the job seeker 14 can post a video resume as shown in block 90 of FIG. 2B, and check a user login as shown at decision block 94. If the job seeker 14 does not have an account, or if the login is unsuccessful for any other reason as determined at decision block 94, execution of the video employment resume system 10 can proceed to block 86 to sign the job seeker 14 up for an account. Execution of the video employment resume system 10 can then proceed by way of path E (item 96) to FIG. 2E. In the operations represented in FIG. 2E the job seeker 14 selects a password and provides demographic and other types of information. The operations represented in FIG. 2E are described in detail herein.

If the login is successful, as determined at decision block 94 of FIG. 2B, the video resume software required for further interaction with the video resume employment system 10 is downloaded as shown at block 98. Execution can then proceed by way of path D (item 100) to FIG. 2D. At block 164 of FIG. 2D the job seeker 14 begins the process of downloading the software for further interaction with the video resume employment system 10. The subsequent operations represented in FIG. 2D are described in detail below.

As previously described, if the job seeker 14 does not have a web camera as shown in block 76 of FIG. 2B execution proceeds by way of path C (item 80) to FIG. 2C where a decision is made at location 106 whether the job seeker wants a web camera. If the job seeker 14 does not want a web camera, the job seeker 14 can schedule an appointment with the personnel of the system 10 for the creation of a video resume as shown in block 108.

If a job seeker 14 plans to purchase a web camera, a decision is made in decision block 104 whether he/she will buy the camera at a retail store and install it on their own PC as shown in block 102. Alternately, a job seeker 14 can obtain a web camera from the provider of the system of this invention as shown in block 110. Whether the job seeker 14 buys the web camera from the provider or from a retail store or from any other source, the job seeker 14 downloads the software and the instructions to create the video resume as shown in block 112.

Execution can then proceed by way of path D (item 100) to FIG. 2D. When the video resume software is downloaded as shown in block 164 of FIG. 2D (as described above), the login status of the job seeker 14 is reviewed in decision block 166. If the job seeker is not logged in, a determination is made whether the job seeker 14 can log in at that point as shown in decision block 168. If the job seeker can not log in, execution can proceed by way of path E (item 96) to the page of the system 10 for creating a user profile page as shown in block 169.

When the software is downloaded along with the installation instructions as shown in blocks 171,172 the requirements of the system being used by the job seeker 14 are determined as shown in block 174. A call can then be made to the media player as shown in decision block 180. Execution can thus proceed to block 178 where a media player can be downloaded if required. Alternatively, if a media player is already present as determined in decision block 180, execution can proceed to decision block 188 where a determination is made whether the appropriate drivers are available. If the drivers are not available, a link can be provided to download them as shown in block 186. When the media player and the appropriate drivers are installed, the download can begin as shown in block 192.

Self-extracting executable files can be downloaded as shown in block 176 and software can be installed to the local PC as shown in the block 182. In a preferred embodiment of the invention, a determination can then be made whether there is a web camera as shown in decision block 190. Execution can proceed to block 184 if the job seeker 14 needs to buy a camera.

If a camera is present as determined in decision block 190 it is selected and the options for the camera settings are determined as shown in blocks 194, 196. A determination is made in decision block 198 whether there is a sound card and if so which one is present. If there is no sound card or if there is an unrecognized sound card execution can proceed to the buy camera page as shown in block 184.

If there is a sound card, it is selected and its options are set as shown in blocks 200, 202. The microphone is tested in decision 208. If there is no microphone or if it does not operate properly execution can go to the buy camera page as shown in block 184. If the microphone tests properly, the sign-in/sign-out option is presented and the video resume can be recorded as shown in blocks 204, 206. Execution within the system 10 can then proceed by way of path G (item 203) to FIG. 2G to create the video resume.

When recording a video resume, a decision is made whether the resume recording session is intended for making a video resume for general use, or for making one for a specific job application as shown in decision block 352 of FIG. 2G. If a video resume for general use is being created by the job seeker 14 as shown in block 350, appropriate instructions are provided to the job seeker 14 via block 358. The recording can then be made as shown in block 362. When the recording of the video resume is stopped as shown in block 368, the video resume can be previewed by the job seeker 14. A determination can be made whether the job seeker 14 wants to post the video resume as shown in decision block 382. If the job seeker 14 does not wish to post the video, the job seeker 14 can cancel the preview as shown in block 380 and get further instructions or record again as shown in blocks 358, 362.

If the job seeker 14 does want to post the recording as determined in decision block 382, the recording can be posted as shown in block 386. The personnel of the system of the present invention can then review the posted recording to determine whether it is adequate as shown in decision block 400. If the video resume is not acceptable, an email of rejection can be sent to the job seeker 14 as shown in block 396. If the video resume is acceptable, an email confirming that it is acceptable can be sent to the job seeker 14 as shown in block 406. The video resume can then be posted by the personnel of the system of the present invention as shown in block 408 for review by potential employers 18.

If a video resume for a specific job is being created by the job seeker 14 as shown in block 356, appropriate instructions are provided to the job seeker 14 in block 360. The recording can then be performed as shown in block 364. When the recording of the video resume is stopped as shown in block 372, the video resume can be previewed by the job seeker 14. A determination can be made whether the job seeker 14 wants to post the video resume as shown in decision block 392. If the job seeker 14 does not wish to post the video, the job seeker 14 can cancel the preview as shown in block 390 and record again.

If the job seeker 14 does want to post the recording as determined in decision 392, the recording can be posted as shown in block 394. The personnel of the system of the present invention can then review the posted recording to determine whether it is adequate as shown in decision block 404. If the video resume is not acceptable, an email of rejection can be sent to the job seeker 14 as shown in block 402. If the video resume is acceptable, an email confirming that it is acceptable can be sent to the job seeker 14 as shown in block 410. The video resume can then be posted by the personnel of the system of the present invention as shown in block 412 for review by employers 18 and a confirmation can be sent as show in block 414.

When the job seeker 14 wants to create a user profile page as previously described, for example by way of block 169 and path E (item 96 of FIG. 2D), execution can proceed to block 250 of FIG. 2E. At block 250 the job seeker 14 can select a unique user name and a unique password. Demographic information can then be entered by the job seeker 14 as shown in block 252. User profile information is accepted until the profile of the job seeker 14 is complete as shown in block 256. The information regarding the type of position, experience and education of the job seeker 14 is collected until they are complete as shown in blocks 258, 260 and 264.

The job seeker 14 can review the material entered in blocks 258, 260 and 264 as shown in decision block 266. If the job seeker 14 is satisfied with the information provided it can be submitted to the video employment resume system 10 as shown in decision block 268. If the job seeker 14 is not satisfied execution can return to block 256 to enter additional data or to change the data previous entered.

If the material is submitted by the job seeker 14, as determined at decision block 266, it is then reviewed by the personnel of the provider of the system 10 according to its business rules and procedures. In this review process, all required fields can be checked to make sure they are filled in a preferred embodiment. Additionally, a determination can be made whether the job seeker 14 has a web camera connected to the PC as determined of decision block 268. If the job seeker 14 does not have a web camera connected to the PC, he or she can be instructed regarding recording alternatives as shown in block 270.

If a web camera is detected and the required data is complete as determined in decision block 268, a data base record can be created for the job seeker 14 as shown in block 272. Additionally, disk space is allocated for the video resume of the job seeker 14. Instructions can then be provided to the job seeker 14 to assist the job seeker 14 in recording and uploading a video resume. The software and instructions useful for this procedure can be provided by block 274.

When the job seeker 14 completes the operations of block 274, the job seeker 14 can proceed by way of path F (item 64) to search the jobs page of the system 10 as shown in block 290 of FIG. 2F. The job search can be performed by the job seeker 14 with respect to any number of parameters. For example, the parameters can include position, location and the industry of the job as shown in block 292. When the job seeker 14 submits the search criteria as shown in block 294, search results can be provided as shown in block 296. The search results can include hyperlinks listed by post date, location and company.

The job seeker 14 can click on a desired job if one is located in the search results as shown in block 298. The job details can be viewed as shown in decision 304. The job details can also be stored in a user profile for review later, as shown in block 316.

If the job seeker 14 wishes to apply for a job at that time or upon returning to the stored details at a later time, the login status of the job seeker 14 can be checked as shown in decision block 302. If the job seeker 14 does not have an account as determined in decision block 302, the job seeker 14 can proceed to the create user profile page as shown in block 312 by way of path E (item 96) to FIG. 2E.

If the user login is successful as determined in decision block 302, the job seeker 14 can go to the user profile as shown in block 308 and check for a the existing video resume as shown in decision block 318. If no video resume is on file as by the job seeker 14 determined in decision block 318, the job seeker 14 can go to the create video resume page as shown in block 320 and connectors 203 to FIG. 2G.

The job seeker 14 can review the video resume as shown in decision 322. If creation of a resume or the editing of a video resume is desired, the job seeker 14 can proceed to the create video resume page as shown in block 320 by way of path G (item 203). If the job seeker 14 determines that no editing of the video resume is required, then the video resume can be submitted by email to the employer 18 as shown in block 324. In a preferred embodiment of the invention, the job seeker 14 can be provided with an email confirmation when the video resume is transmitted to the employer 18.

As previously described and as shown in FIG. 2A, when the job seeker 14 visits the home page 50 of the system 10 of the present invention, the job seeker can go to the job seeker home page 54. In the same manner, an employer 18 visiting the home page 50 of the video employment resume system 10 can proceed by way of the home page 50 to the employer home page 58 represented in FIG. 2H.

The employer home page 58 can have a start page 352 as shown in FIG. 2H. From the employer start page 352 the employer 18 can post a job as shown in block 350, search the video resume data base as shown in block 354, or create an account to use the system 10 as shown in block 356.

If the employer posts a job, execution can proceed by way of block 350 and path I (item 207) to post job as shown in block 401 in FIG. 2J. A determination is first made whether the user can log in as shown in decision block 403. If there is no account for the employer, execution proceeds by way of path H (item 205) to the operations set forth in FIG. 2I for entering a new company account. These operations are described in detail below.

If the employer 18 can log in, the employer 18 can determine the job posting profile of the job and retrieve company data stored during a previous visit to the web page 352 as shown in blocks 407 and 409 in FIG. 2J. The retrieved data can include job descriptions, the length of time a job has been posted and payments made by the employer 18, as shown in blocks 411 and 413.

The employer 18 can choose to view the data as shown by decision block 417 and then proceed to block 409 for additional data, if desired. Transactions for payment by credit card or billing of the user can take place as shown in block 419. Additionally, the employer 18 can post the job to the website of the system 10 as shown in block 421.

Returning now to FIG. 2H, if the employer wishes to search the video resume data base as shown in block 354, execution can proceed by way of path J (item 209) as previously described in order to search the video resume data base page as shown in block 450 of FIG. 2K. The employer 18 can then specify the employment profile of the desired job seekers 14 as shown in block 451 and submit the search as shown in block 454. At the completion of the search, the employer 18 is presented with search results. The search results can include hyperlinks for directing the employer 18 to the video resume candidates who are in compliance with the job seeker profile submitted by the employer 18 in block 451 as shown in block 458.

The employer 18 can review the search results and click on a desired candidate as shown in block 460. The selected video resume can be viewed by the employer 18 as shown in decision block 464. The profile of the job seeker 14 can also be stored for later viewing by the employer 18 as shown in block 472. If a job seeker 14 that the employer 18 selects, e.g., clicks on, is determined not to be suitable, the employer 18 can cancel the selected job seeker 14 as shown in block 468. The employer 18 can then obtain information on a different job seeker 14 by returning to the search results as shown in block 458 and clicking on a different candidate.

If a job seeker 14 reviewed by the employer 18 is determined to be suitable, the employer 18 can contact the job seeker 14 and set up a personal interview as shown in block 462. The job seeker 14 can present the employer 18 with contact information in order to facilitate the evaluation being performed by the employer 18 as shown in block 470.

Returning again to FIG. 2H, if the employer 18 must create an account in order to use the website of the system of the present invention, execution can proceed from start page decision block 352 to “create an account to use our website” block 356, as shown in FIG. 2H. Execution can then proceed by way of path H (item 205) to select the employer 18 name and password as shown in block 362 of FIG. 2I. In block 362 of FIG. 2I, the employer 18 can thus select a user name and password. The company profile of the employer 18 is entered as shown in block 364. The information can include, for example, the company name, a contact name, an email address, a phone and a zip code as shown in block 366. The employer 18 can review the entered material as shown in decision block 368 and return to block 366 to make corrections as many times as necessary.

The information entered by the employer 18 in this manner can then be submitted to the video employment resume system 10. The business rules process of the system 10 can be used to determine whether all of the required fields are filled in by the employer 18 as shown in decision block 370. If all of the required fields are not filled in, execution can return to block 366 in order to permit the required data to be entered. When the data entry is completed, the employer 18 can be informed that the account is active, as shown in block 372.

While the invention has been described in detail and with reference to specific examples thereof, it will be apparent to one skilled in the art that various changes and modifications can be made therein without departing from the spirit and scope thereof.

What is claimed is:

1. A video resume employment method for determining the employability of a job seeker by an employer using a video resume employment system, comprising:
a. providing a video employment resume of said job seeker, said video employment resume including employment information with respect to said job seeker for making an employment related determination by said employer;
b. transmitting said video employment resume to said video employment resume system;
c. storing said transmitted video employment resume in a video resume database;
d. accessing said video employment resume from said video resume database by said employer from a location remote from said video employment resume system to provide an accessed video resume;
e. viewing said accessed video resume by said employer; and
f. determining said employability of said job seeker by said employer in accordance with said viewing of said accessed video resume.

2. The video employment resume method of claim 1, comprising making said video employment resume by said job seeker.

3. The video employment resume method of claim 1, comprising transmitting a video recording device to said job seeker by said video resume employment system for said providing of said video employment resume by said job seeker.

4. The video employment resume method of claim 1, wherein said providing of said video employment resume includes the verbally describing said employment information by said job seeker.

5. The video employment resume method of claim 1, comprising transmitting said video employment resume by way of the Internet.

6. The video employment resume method of claim 1, wherein said storing of said video employment resume comprises:
a. receiving a plurality of said video employment resumes; and
b. storing the video employment resumes of said plurality of video employment resumes in said video resume database.

7. The video employment resume method of claim 6, comprising sorting the video employment resumes of said plurality of video employment resumes in accordance with a selected job related parameter.

8. The video employment resume method of claim 7, wherein said job related parameter comprises occupation.

9. The video employment resume method of claim 7, wherein said job related parameter comprises education.

10. The video employment resume method of claim 7, wherein said job related parameter comprises work experience.

11. The video employment resume method of claim 7, wherein said job related parameter comprises geographic location.

12. The video employment resume method of claim 1, wherein said accessing of said video employment resume comprises accessing by way of the Internet.

13. The video employment resume method of claim 1, comprising forwarding said accessed video resume to a further location, said further location being remote from said video employment resume system and from said accessing employer.

14. The video employment resume method of claim 13, comprising forwarding said accessed video resume to said further location by way of the Internet.

15. The video employment resume method of claim 1, comprising providing an employment interview in accordance with said employability determination.

16. The video employment resume method of claim 1, in a system having a plurality of job seekers each having a corresponding video employment resume, comprising:
a. providing said employer with a list of job seekers of said plurality of job seekers;
b. selecting a job seeker from said list of job seekers by said employer in accordance with an employability determination; and
c. transmitting by said employer an identification of said selected job seeker to said video employment resume system.

17. The video employment resume method of claim 16, comprising transmitting a corresponding video employment resume from said video employment resume database to said employer in accordance with said job seeker identification.

18. The video employment resume method of claim 16, comprising listing a help wanted ad on said video employment resume system by said employer to provide a listed help wanted ad.

19. The video employment resume method of claim 18, comprising:
a. viewing said listed help wanted ad by a viewing job seeker; and
b. responding to said listed help wanted ad by viewing said job seeker in accordance with said viewing of said listed help wanted ad.

20. The video employment resume method of claim 19, comprising transmitting a responding resume to said listing employer by way of said video employment resume system.

21. The video employment resume method of claim 20, in a system having a plurality of said video employment resume systems, each video employment resume system of said plurality of video employment resume system having corresponding listing employers wherein said responding resume is stored on a first video employment resume system, comprising transmitting said responding resume to a listing employer on a second video employment resume system differing from said a first video employment resume system.

22. A video resume employment system for determining the employability of a job seeker by an employer, comprising:
a. means for creating a video employment resume of said job seeker, said video employment resume including employment information with respect to said job seeker for making an employment related determination by said employer;
b. means for transmitting said video employment resume to said video employment resume system;
c. means for storing said transmitted video employment resume in a video resume database;
d. means for accessing said video employment resume from said video resume database by said employer from a location remote from said video employment resume system to provide an accessed video resume; and
e. means for viewing said accessed video resume by said employer, wherein said employability of said job seeker is determined by said employer in accordance with said viewing of said accessed video resume.

23. The video employment resume system of claim 22, wherein said video employment resume is created by said job seeker.

24. The video employment resume system of claim 22, further comprising an Internet connection for transmitting said video employment resume.

25. The video employment resume system of claim 22, further comprising a plurality of said video employment resumes wherein the video employment resumes of said plurality of video employment resumes are stored in said video resume database.

26. The video employment resume system of claim 22, further comprising a further location remote from said video employment resume system and from said accessing employer wherein said accessed video resume is forwarded to said further location.

27. The video employment resume system of claim 22, including a plurality of job seekers each having a corresponding video employment resume, further comprising:
a. a list of job seekers of said plurality of job seekers;
b. a selected job seeker from said list of job seekers selected by said employer in accordance with an employability determination;
and
c. an identification of said selected job seeker for transmission by said employer to said video employment resume system.
